(19) United States
(12) Patent Application Publication
(10) Pub. No.: US 2018/0126853 A1
(43) Pub. Date: May 10, 2018

(54) CURRENT COLLECTOR, CONDUCTOR RAIL SYSTEM, AND SLIDING CONTACT

(71) Applicant: Conductix-Wampfler GmbH, Weil am Rhein (DE)

(72) Inventor: Hans-Jürgen SCHMITT, Eimeldingen (DE)

(73) Assignee: Conductix-Wampfler GmbH, Weil am Rhein (DE)

(21) Appl. No.: 15/704,876

(22) Filed: Sep. 14, 2017

(30) Foreign Application Priority Data
Sep. 15, 2016 (DE) 10 2016 117 412.2

(51) Int. Cl. B60L 3/04; H01H 71/08; B60L 5/38; B60M 1/30

(52) U.S. Cl. CPC B60L 3/04; B60M 1/30; B60L 5/38; H01H 71/08

(57) ABSTRACT

A current collector for an electrical load with at least one sliding contact carrier for a sliding contact for making contact with at least one electrically conducting conductor profile of a conductor rail. The sliding contact can be electrically conductively connected to an electrical terminal box of the electrical load to a conductor rail system with a conductor rail and at least one electrical load moving on the conductor rail in the longitudinal direction thereof and comprising a current collector with at least one sliding contact for making contact with at least one electrically conducting conductor profile of the conductor rail. The sliding contact is electrically conductively connected to an electrical terminal box of the electrical load, and to a sliding contact for a current collector of an electrical load moving on a conductor rail in the longitudinal direction thereof. The sliding contact can be electrically conductively connected to an electrical terminal box of the electrical load.

### FIELD OF THE DISCLOSURE

The disclosure relates to a current collector, a conductor rail system, and a sliding contact.

### BACKGROUND

In conventionally known conductor rail systems, electrical loads that move along a conductor rail are supplied with current and voltage by means of electrically contacting sliding contacts on the conductor strands of the conductor rail. To this end, current collectors of electrical loads, as a rule, comprise a plurality of sliding contacts, typically carbon brushes, that are disposed in sliding contact carriers. The sliding contact carriers are most commonly pushed by spring action against the conductor strands of the conductor rail. The individual sliding contacts are typically routed via long—frequently several meters long—supply lines to a terminal box of the electrical load, from which the electrical power is further distributed. To ensure that in the event of an electrical fault, e.g., a short circuit in the electrical appliances of the electrical load, transmission of dangerously high currents are avoided, circuit interrupting devices for the supply lines are typically provided in the terminal box. Similarly, on the side of the conductor rail, the individual conductor strands of the conductor rail are individually or jointly protected against excess currents by means of an additional circuit interrupting device. The use of circuit interrupting devices is known from the prior art.

Thus, DE 1 725 890 discloses a motor circuit interrupting device for electric motors for auxiliary operations on electric vehicles, wherein a vehicle motor is connected via a circuit interrupting device to a trolley wire line.

DE 2 312 863 discloses a steering system for mobile shelf trucks that are connected via sliding contacts to a conductor rail. In this system, the electric drives of the individual shelf trucks are protected against excess current by means of circuit interrupting devices disposed in the feeder lines to the sliding contacts.

The disadvantage of the prior-art systems is that the supply lines extending from the sliding contacts to the terminal box must be designed for the maximum current safeguarded by the circuit interrupting devices. This requires that the supply lines have a sufficiently large conductor cross-section, which during standard operation is not needed, which results in unnecessarily high material consumption for the supply lines.

### SUMMARY

Thus, the disclosure includes a current collector, a sliding contact, and a conductor rail system that eliminate the disadvantages mentioned above and ensure a safe and, at the same time, material-conserving current transfer to the electrical load.

Other modifications and embodiments of the current collector, the sliding contact, and the conductor rail system are also disclosed.

According to an embodiment of the present disclosure, the current collector is characterized in that an electrical circuit interrupting device is disposed between the sliding contact and the connection to the electrical load.

This circuit interrupting device can be advantageously disposed in or on the sliding contact, thereby making it possible to keep the conducting path between the circuit interrupting device and the sliding contact very short or even at zero.

According to an advantageous embodiment of the present disclosure, the circuit interrupting device can be disposed on the current collector, which allows the circuit interrupting device for one or, optionally, for a plurality of sliding contacts to be disposed very close to the sliding contact. Most preferably, the circuit interrupting device can be disposed on the sliding contact carrier, making it possible to easily dedicate a separate circuit interrupting device to each sliding contact.

According to an advantageous advanced modification, the circuit interrupting device can be disposed in a supply line extending from the sliding contact or sliding contact carrier to the electrical connection of the load connector, with the circuit interrupting device preferably being disposed close to the sliding contact or the sliding contact carrier.

According to an embodiment that offers benefits in terms of ease of assembly, the circuit interrupting device can be replaceable, which, in the event of an electrical fault, allows a destroyed circuit interrupting device to be replaced as quickly and easily as possible. This can be an advantage, especially when using fusible circuit interrupting devices or other circuit interrupting devices that, in the event of an electrical fault, are designed to be destroyed. The circuit interrupting device is preferably a plug-in circuit interrupting device that can be plugged into a circuit interrupter socket as preferably provided. This circuit interrupter socket can be disposed preferably on the sliding contact, on the current collector, and/or on the sliding contact carrier.

In addition, it can be an advantage if a first contact of the circuit interrupting device can make electrical contact with the sliding contact or a sliding contact holder that is electrically conductively connected to the sliding contact.

The electrical conducting path between the sliding contact and the circuit interrupting device can advantageously have a maximum length of 15 cm, preferably a maximum length of 8 cm, and most preferably a maximum length of 3 cm.

According to an embodiment of the present disclosure, the conductor rail system is characterized in that an electrical circuit interrupting device is disposed between the sliding contact and the connection to the electrical load. To this end, a current collector and/or the sliding contact mentioned above and described below can be preferably used.

In addition, according to an embodiment of the present disclosure, the sliding contact is characterized in that the circuit interrupting device is disposed in or on the sliding contact. This allows the spacing between the sliding contact and the circuit interrupting devices to be kept as short as possible or even, in the ideal case, to be completely eliminated.

### BRIEF DESCRIPTION OF THE DRAWINGS

The present disclosure will be described in greater detail below based on practical examples with reference to the accompanying drawings. In these drawings:

FIG. 1 shows a lateral, partially sectioned top view of a section of the conductor rail system according to the present disclosure;

FIG. 2 shows a sectional top view of the front end of the conductor rail system seen in FIG. 1;

FIG. 3 shows a diagrammatic, partially sectioned detail view of the sliding contact carrier according to the present disclosure seen in FIG. 1;

FIG. 4 shows a diagrammatic, partially sectioned detail view of the alternative sliding contact carrier according to the present disclosure seen in FIG. 3;

FIG. 5 shows a diagrammatic, partially sectioned detail view of another alternative sliding contact carrier according to the present disclosure as seen in FIG. 3;

FIG. 5A shows a cross-section through the circuit interrupter socket and the circuit interrupting device along the dash-dotted cutting line A-A of FIG. 5.

### DETAILED DESCRIPTION

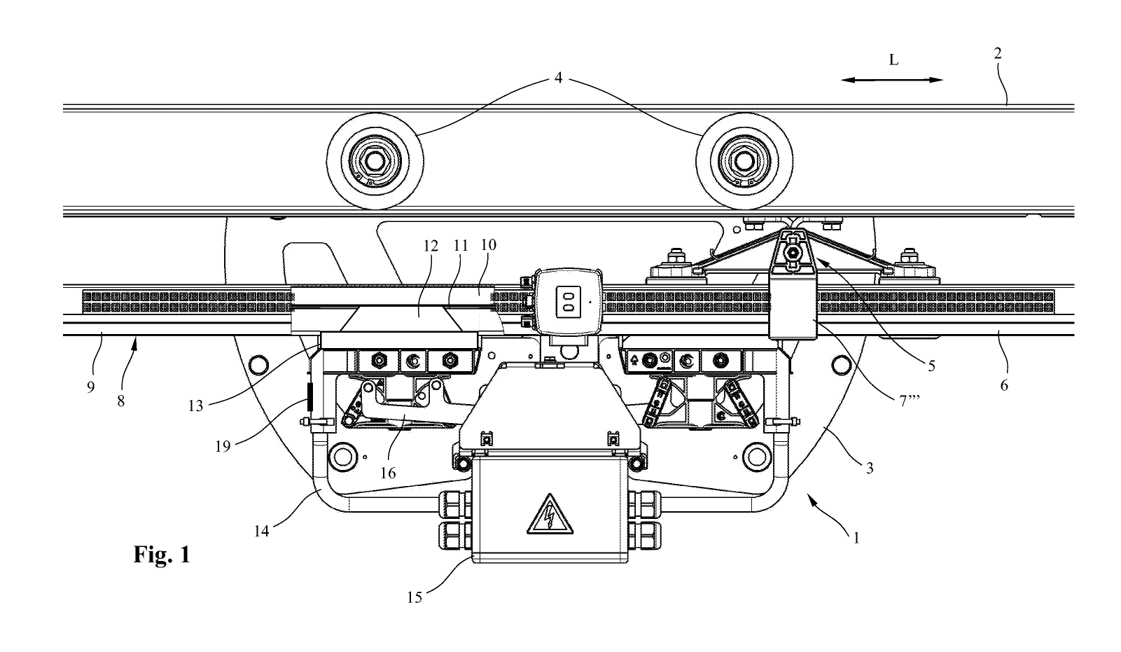

FIG. 1 shows a lateral top view of a section of the conductor rail system 1 according to the present disclosure, comprising a substantially double U-shaped track section 2. Along the track section 2, a current collector 3 of an electrical load (not shown) can be moved in a longitudinal direction L of the track section 2 by means of track rollers 4. The current collector 3 serves to supply the electrical load moving along the track section 2 as well as the electrical appliances installed thereon, for example, a container crane having a variety of electrical propulsion and lifting drives.

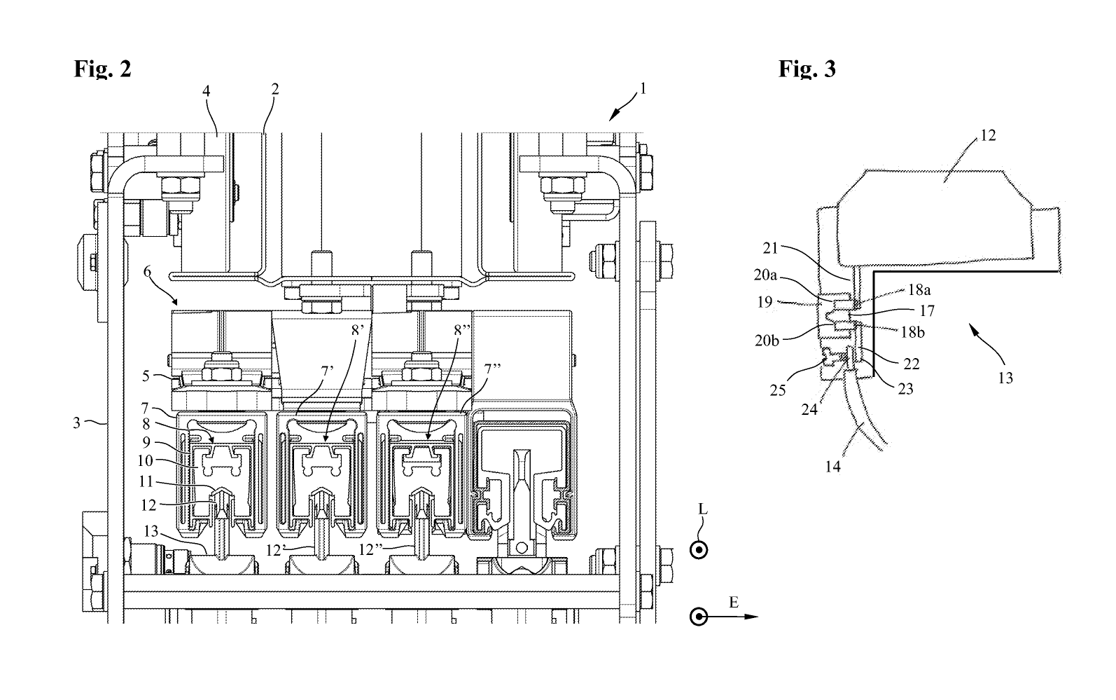

On the lower face of the track section 2, a conductor rail 6 is suspended by means of conductor rail holders 5 that are attached, separated from each other, along the longitudinal direction L of the track section 2. The conductor rail 6 comprises three conductor strand holders 7, 7′, 7″ disposed side by side and readily visible in FIG. 2 for holding elongated phase conductor strands 8, 8′, and 8″. Since the phase conductor strands 8′ and 8″ have a design identical to that of the phase conductor 8, the explanations given for the phase conductor strands 8 apply mutatis mutandis.

The phase conductor strand 8 has an elongated insulating profile 9 that is held by the conductor strand holder 7. In turn, an elongated electrically conducting phase conductor profile 10 with an electrically conducting elongated sliding surface 11, preferably made of aluminum or steel, is inserted into the insulating profile 9.

A sliding contact 12 in the form of a carbon brush disposed on the sliding contact carrier 13 of the current collector 3 slides along the sliding surface 11. Via an electrical supply line 14 disposed on the sliding contact carrier 13, the sliding contact 12 is connected to a terminal box 15 of the electrical load, from which the electrical appliances can be supplied with electric current and voltage, for example, via an electrical supply network of the electrical load.

In addition, the sliding contact carrier 13, in conjunction with the sliding contact 12, can be moved in a manner known in the art in the direction of, and away from, the sliding surface 11 by means of a feed mechanism 16 known in the art and shown by way of an example in FIG. 1.

During operation, the sliding contact 12 is continuously pushed against the sliding surface 11, for example, by spring action. Other sliding contacts 12′ and 12″ as shown in FIG. 2, with their associated sliding contact carriers, have a design that is largely identical to that of the sliding contact 12 and the sliding contact carrier 13 so that the explanations previously given apply mutatis mutandis. In particular, each sliding contact 12, 12′, and 12″ has its own feed mechanism 16.

The phase conductor strand 8 serves to supply the mobile electrical load with power and carries live voltage during standard operating conditions, which means that current flows across the sliding surface 11 to the sliding contact 12. The embodiment described above is known to those skilled in the art and therefore does not require further explanation.

As the diagrammatic detail view of the sliding contact carrier 13 in FIG. 3 illustrates, a plug-in socket 17 with contacts 18a, 18b for a blade-type plug-in circuit interrupting device 19 known in the art with plug-in contacts 20a, 20b is disposed on the sliding contact carrier 13, said blade-type plug-in circuit interrupting device being used, for example, in the automotive sector and (thus) being standardized according to ISO 8820-3. However, other circuit interrupting devices and types of circuit interrupting devices can also be used.

The first contact 18a (in FIG. 3 seen at the top and closer to the sliding contact 12) of the plug-in socket 17 for the first plug-in contact 20a of the plug-in circuit interrupting device 19 is electrically conductively connected to the sliding contact 12 by means of a first connecting line 21. On the other contact 18b of the plug-in socket 17 for the second plug-in contact 20b of the plug-in circuit interrupting device 19, a second connecting line 22 extends to a supply port 23 for the supply line 14 of the electrical load. To this end, the supply line 14 comprises a connecting lug 24 that, in a manner known in the art, can be detachably connected to the supply port 23 by means of a mounting bolt 25.

Since the circuit interrupting device 19 is disposed very close to the sliding contact 12, the first connecting line 21 that extends between the sliding contact 12 and the circuit interrupting device 19 can be kept as short as possible. The length of the spacing in between preferably measures only a few millimeters to a few centimeters. Therefore, only the first connecting line 21 must have the conductor cross-section required for the maximum current safeguarded by the circuit interrupting device 19 in the event of an electrical fault.

FIG. 4 shows a diagrammatic, partially sectioned detail view of an alternative sliding contact carrier 113 that is largely identical to the sliding contact carrier 13 shown in FIG. 3. Thus, the explanations given for the sliding contact carrier 13 also apply mutatis mutandis to the sliding contact carrier 113. Identical components are therefore also identified by identical reference characters, and components having identical functions are identified by identical reference characters but are preceded by “1,” i.e., sliding contact 112 in FIG. 4 corresponds to sliding contact 12 in FIG. 3.

The embodiment of the sliding contact carrier 113 shown in FIG. 4 differs from the sliding contact carrier 13 shown in FIG. 3 mainly in that an alternative sliding contact 112 itself forms contact 121, making direct electrical contact with the plug-in contact 20a of the plug-in circuit interrupting device 19. In this case, the connecting line 21 shown in FIG. 3 between the plug-in socket 17 and the sliding contact 13 can be completely eliminated, thereby allowing the spacing between the plug-in circuit interrupting device 19 and the sliding contact 112 to be shortened even more and in a practical sense to be reduced to zero.

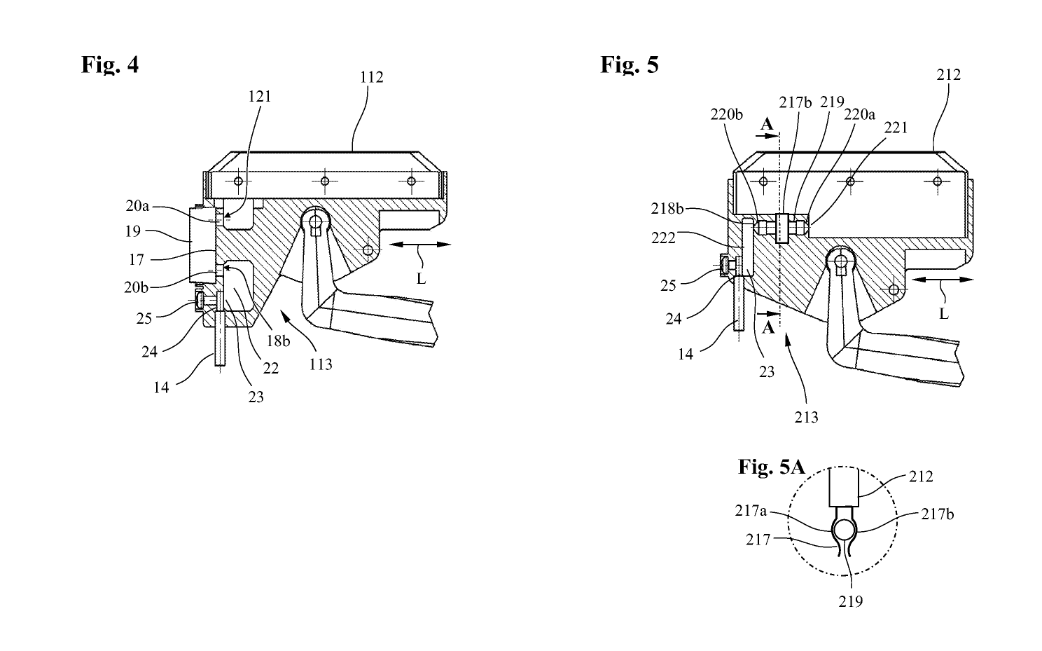

In a preferred embodiment, which is diagrammatically shown in FIG. 5 and described in greater detail below, the circuit interrupting device or a socket for the circuit interrupting device can also be directly integrated into the sliding contact, in particular into a carbon brush. This makes it possible to shorten the connecting line between the circuit interrupting device and the sliding contact even more, and most preferably to eliminate it completely. In addition, this simplifies the replacement of the circuit interrupting device, especially since the sliding contact already is designed to be replaceable in anticipation that, over time, it will be subject to wear and tear and will have to be replaced. However, other types of circuit interrupting devices can also be used.

FIG. 5 shows a diagrammatic, partially sectioned detail view of another alternative sliding contact carrier 213 according to the present disclosure that is largely identical to the sliding contact carrier 13 shown in FIG. 3. Thus, the explanations given for the sliding contact carrier 13 and the sliding contact carrier 113 also apply mutatis mutandis to the sliding contact carrier 213. Identical components are therefore also identified by identical reference characters, and components having identical functions are identified by identical reference characters but are preceded by “2,” i.e., sliding contact 212 in FIG. 5 corresponds to sliding contact 12 in FIG. 3.

The embodiment of the sliding contact carrier 213 shown in FIG. 5 differs from the sliding contact carrier 13 shown in FIG. 3 mainly in that an alternative sliding contact 212 itself forms contact 221, making direct electrical contact with a first contact 220a of a plug-in circuit interrupting device 219 on the sliding contact side. A second contact 220b of the plug-in circuit interrupting device 219 subsequently makes contact with a contact 218b of a connecting line 222 between the circuit interrupting device 219 and the supply port 23.

This offers the advantage that the connecting line 21 shown in FIG. 3 between the plug-in socket 17 and the sliding contact 13 can be completely eliminated, thereby further shortening the spacing between the plug-in circuit interrupting device 19 and the sliding contact 212 and, in a practical sense, reducing it to zero.

In addition, the sliding contact 212 comprises an alternative circuit interrupter socket 217 for detachably holding the circuit interrupting device 219. Since the sliding contact 219, which is typically made of copper, graphite, or similar suitable materials and which is known to those skilled in the art, is subject to wear and tear over time, this solution offers the advantage that the sliding contact 212, in conjunction with the circuit interrupting device 219, can be easily and quickly replaced. In this manner, it can be ensured that every time the sliding contact 212 is replaced, a functionally reliable circuit interrupting device 219 is installed, without the need to separately check and, when required, replace the circuit interrupting device 219.

The detail drawing of FIG. 5A shows a cross-section through the circuit interrupter socket 217 and the circuit interrupting device 219 along the dash-dotted cutting line A-A of FIG. 5. In this drawing, the circuit interrupter socket 217 comprises two oppositely lying retaining legs 217a, 217b that grip and thereby retain the circuit interrupting device 219. To further improve the grip, the retaining legs 217a, 217b can be designed to conform to the outside contour of the circuit interrupting device 219; for example, they can bulge outwardly as shown in the detail drawing of FIG. 5A. As an alternative or in addition thereto, the free ends of the retaining legs 217a, 217b can converge conically toward each other, with the spacing between the retaining legs 217a, 217b being less than the width of the circuit interrupting device 219. As a result, the circuit interrupting device 219 is pushed against the resistance of the legs 217a, 217b, which are thereby slightly pulled apart, and into the circuit interrupter socket 217 and subsequently is positioned between the two bulges of the retaining legs 217a, 217b and thereby secured against accidentally falling out.

It is, however, also possible to use other types of circuit interrupter sockets, or, for example, two circuit interrupter sockets 217 disposed side by side instead of only one circuit interrupter socket 217. A circuit interrupter socket can also be made of the same material of which the sliding contact 219 is made.

As an alternative, the circuit interrupting device 219 in the embodiment shown in FIG. 5, instead of being replaceably disposed on the sliding contact 212, can also be replaceably disposed on the sliding contact carrier 213, thereby retaining the advantage that a direct electrical contact between the circuit interrupting device 219 and the sliding contact 212 is ensured. To this end, the circuit interrupter socket 217 shown in the detail drawing of FIG. 5 can optionally also be disposed on the sliding contact carrier 213.

To allow the sliding contacts 12, 112, and 212 to be easily and quickly replaced, the sliding contacts 12, 112, and 212 can preferably be detachably connected to the sliding contact carriers 13, 113, and 213, respectively.

In addition, the sliding contacts 12, 112, and 212 can also be received by an additional sliding contact holder that is preferably integrally formed in one piece together with the sliding contacts 12, 112, and 212. In this case, the sliding contact holder, in conjunction with the sliding contacts 12, 112, and 212, can be connected to, or more specifically, inserted into, the sliding contact carriers 13, 113, and 213. If the sliding contact holder is made of an electrically conducting material or if it is coated with such a material on one or more surfaces facing the sliding contact 212 and, in addition thereto, is electrically conductively connected to the sliding contacts 12, 112, and 212, preferably over a large area of the lateral surfaces thereof, the direct electrical contact between the circuit interrupting device 19 and 219 shown in FIGS. 4 and 5, respectively, can also be established with the sliding contact holder instead of with the sliding contact 12, 112, and 212, respectively. At the same time, the spacing between, respectively, the circuit interrupting device 19 and 219 and the sliding contact 112 and 212 is further reduced, thereby making it possible to eliminate an additional connecting line between the socket 17 the sliding contact 12, as shown in FIG. 3. This applies especially if electrical contact between the sliding contact holder and the sliding contact is established over a large area.

In addition, the circuit interrupter socket can preferably also be made of the same material as the sliding contact and/or the sliding contact carrier, thereby eliminating the need for an additional component for the circuit interrupter socket. Thus, to receive the circuit interrupting device, the sliding contact carrier can have a recess that, for the sake of creating the circuit interrupter socket, has a cross-section that conforms to the shape of the circuit interrupting device. For example, the sliding contact carrier 213 seen in FIG. 5 can have a recess in the area of the circuit interrupting device 219, with the circuit interrupter socket 217 being made of the same material as the sliding contact carrier 213 with a conical opening that, in FIG. 5, is open toward the top, i.e., facing the sliding contact 219. This can be advantageously implemented if the sliding contact carrier 213 is made of an electrically insulating material, in particular a plastic material.

According to another embodiment of the present disclosure (not shown in the drawings), the circuit interrupting device can be disposed on, or integrated into, the supply line 14. In this case, the circuit interrupting device can preferably be disposed on the current collector-side end of the supply line, thereby ensuring that the spacing toward the sliding contact is kept as short as possible.

### LIST OF REFERENCE CHARACTERS

1 Conductor rail system
2 Track section
3 Current collector
4 Track rollers
5 Conductor rail holders
6 Conductor rail
7, 7′, 7″ Conductor strand holders
8, 8′, 8″ Phase conductor strands
9 Insulating profile
10 Phase conductor profile
11 Sliding surface on the phase conductor strand
12, 12′, 12″ Sliding contacts
13 Sliding contact carrier
14 Supply line to the electrical load
15 Terminal box
16 Feed mechanism
17 Plug-in socket
18a, 18b Contacts on the plug-in socket
19 Plug-in circuit interrupting device
20a, 20b Plug-in contacts on the circuit interrupting device
21 Connecting line between the plug-in socket and the sliding contact
22 Connecting line between the plug-in socket and the electrical load
23 Supply port of the supply line
24 Connecting lug
25 Mounting bolt
112 Alternative sliding contact
113 Alternative sliding contact carrier
121 Contact formed by sliding contact [112]
212 Additional alternative sliding contact
213 Additional alternative sliding contact carrier
217 Circuit interrupter socket
217a, 217b Retaining legs
218b Contact on the connecting line
219 Fusible circuit interrupting device
220a, 220b Contacts on the circuit interrupting device
221 Contact formed by sliding contact [212]
222 Connecting line between the circuit interrupting device and the electrical load
L Longitudinal direction of the conductor rail

What is claimed is:

1. A current collector for an electrical load with at least one sliding contact carrier for a sliding contact for making contact with at least one electrically conducting conductor profile of a conductor rail, wherein the sliding contact can be electrically conductively connected to an electrical terminal box of the electrical load, wherein an electrical circuit interrupting device is disposed between the sliding contact and the terminal box of the electrical load.

2. The current collector of claim 1, wherein the circuit interrupting device is disposed in or on the sliding contact.

3. The current collector of claim 1, wherein the circuit interrupting device is disposed on the current collector.

4. The current collector of claim 3, wherein the circuit interrupting device is disposed on the sliding contact carrier.

5. The current collector of claim 1, wherein the circuit interrupting device is disposed in a supply line extending from the sliding contact or the sliding contact carrier to the electrical terminal box of the electrical load.

6. The current collector of claim 1, wherein the circuit interrupting device is replaceable.

7. The current collector of claim 1, wherein the circuit interrupting device is a plug-in circuit interrupting device.

8. The current collector of claim 1, wherein a plug-in socket for receiving the circuit interrupting device is provided.

9. The current collector of claim 8, wherein the plug-in socket is disposed on at least one of the sliding contact, the current collector, and the sliding contact carrier.

10. The current collector of claim 1, wherein a first contact of the circuit interrupting device makes electrical contact with the sliding contact or with a sliding contact holder that is electrically conductively connected to the sliding contact.

11. A conductor rail system with a conductor rail and with at least one electrical load moving on the conductor rail in the longitudinal direction thereof and comprising a current collector with at least one sliding contact for making contact with at least one electrically conducting conductor profile of the conductor rail, wherein the sliding contact is electrically conductively connected to an electrical terminal box of the electrical load, wherein an electrical circuit interrupting device is disposed between the sliding contact and the terminal box of the electrical load.

12. The conductor rail system of claim 11, wherein the circuit interrupting device is a plug-in circuit interrupting device.

13. A sliding contact for a current collector of an electrical load moving on a conductor rail in the longitudinal direction thereof, wherein the sliding contact can be electrically conductively connected to an electrical terminal box of the electrical load, wherein a circuit interrupting device is disposed in or on the sliding contact.
